(19) United States
(12) Patent Application Publication
(10) Pub. No.: US 2008/0066323 A1
(43) Pub. Date: Mar. 20, 2008

(54) YIELDABLE DRIVE MECHANISM FOR A TOE-KICK SAW

(75) Inventors: Lance D. Crain, Fremont, CA (US); Greg Chambers, Morgan Hill, CA (US); Tan D. Nguyen, Milpitas, CA (US)

Correspondence Address: SCHNECK & SCHNECK, P.O. BOX 2-E, SAN JOSE, CA, 95109-0005, US

(73) Assignee: CRAIN CUTTER COMPANY, INC., Milpitas, CA (US)

(21) Appl. No.: 11/858,803

(22) Filed: Sep. 20, 2007

Related U.S. Application Data
(60) Provisional application No. 60/826,349, filed on Sep. 20, 2006.
(60) Provisional application No. 60/862,359, filed on Oct. 20, 2006.
(60) Provisional application No. 60/942,172, filed on Jun. 5, 2007.

(51) Int. Cl. B23D 45/16

(52) U.S. Cl. 30/388

(57) ABSTRACT

A toe kick saw including a driver having a safety feature to allow a saw blade to disengage during experience of increased torque. The toe kick saw driver may include a one or two piece driver that engages the saw blade that is able to yield by deforming when the blade experiences an increase in torque sufficient to cause kickback. Alternatively the toe kick saw could include a yieldable spindle extension.

### CROSS-REFERENCE TO RELATED APPLICATIONS

This application claims priority from U.S. provisional application No. 60/826,349, filed Sep. 20, 2006; U.S. provisional application No. 60/862,359, filed Oct. 20, 2006; and U.S. provisional application No. 60/942,172, filed Jun. 5, 2007.

### TECHNICAL FIELD

The present device relates generally to flooring installation tools and more specifically to an improved toe-kick saw having enhanced safety features.

### BACKGROUND

A toe-kick saw is a specialty circular saw used in residential floor remodeling. When a finished floor is to be replaced, this often means that the underlayment beneath the finished floor must also be replaced. The “finished floor” is the topmost, exposed layer of flooring selected for décor and utility in the room (typically vinyl, ceramic tile, carpet, hardwood or laminate plank). Beneath the finished floor is underlayment, which is an especially flat, finely finished material. The use of underlayment ensures the finished floor will be installed on a flat surface with no bumps which might poke through the finished floor or create irregularities. Beneath the underlayment is the rough subfloor (normally plywood) which is laid over the joists.

When a finished floor is to be replaced, it is often necessary to replace the underlayment as well. When new vinyl, ceramic tile, or hardwood floors are installed, adhesive is used to adhere the finished floor to the underlayment. In such cases, the finished floor cannot be removed from the underlayment without damaging it.

In many finished floor installations, especially in kitchens and bathrooms, cabinetry is encountered which may have toe-kicks. Toe-kicks are relieved areas at the bottom of the cabinet which allow a person to step closely to the cabinet without stubbing a toe. Often times the cabinetry is installed first before the finished floor is installed, and the cabinetry is installed on top of the underlayment. In the case of a hardwood finished floor, the cabinetry may even be installed on top of the finished floor as well.

Whenever cabinets with toe-kicks are installed on top of the underlayment or finished floor, removing only old underlayment and/or finished floor under the toe-kick can be very difficult. Using conventional hand tools, such as a hammer and chisel, the floor installer would have to chisel out the floor along the entire length of the toe-kick. This chiseling is difficult because the chisel can only be pointed into the corner at a 45 degree angle, not straight downward as required to effectively chisel the material. There is a clear danger of the hammer or chisel striking and damaging the cabinet face. Conventional power saws will not fit underneath the toe space. A specialized power saw is needed which can extend underneath and cut flush up against the inner wall of a toe space.

Toe-kick saws are available for this purpose. As shown in FIG. 1, a typical prior art toe-kick saw 100 consisted of a circular saw motor 120 having a rotating armature (not shown), a primary spindle 140 operatively coupled to the armature, and a means to extend the spindle 150. With respect to the means to extend the spindle, and in regard to both prior art toe-kick saws as well as those of this invention, the preferred means to extend the spindle has included a separate assembly, which will be referred to herein as a “spindle extension assembly” or as a “spindle extension”. However, a separate assembly need not be used. For example, the spindle itself may be elongated. For this reason, the terms elongate spindle, a spindle extension assembly, or a spindle extension shall all be defined and used herein as a means to extend the spindle.

The spindle extension assembly 150 of prior art toe-kick saw 100 includes spindle coupler 160, secondary spindle 200, and set screw 180 which connects spindle coupler 160 and secondary spindle 200. Other means to extend the spindle may be created by persons skilled in the art. For example, a spindle extension may be inserted into a hole in the spindle gear itself and keyed to a slot in the spindle gear. All such will be defined herein as a spindle extension assembly or spindle extension.

The explanation of how spindle extension assembly 150 transmits force to the blade is as follows: Spindle coupler 160 is coupled to primary spindle 140, and also connected to secondary spindle 200 by set screw 180. Thus, when primary spindle 140 turns, secondary spindle 200 is turned. Secondary spindle 200 has flats 210 which may engage flats 310 on blade driver 320. Blade driver 320 has two solid cylindrical drive nubs 330 which engage two drive holes 350 in blade 300. Thus, whenever primary spindle 140 turns, force is transmitted through spindle extension assembly 150 to blade driver 320 and then to blade 300. Blade 300 and blade driver 320 are fastened to secondary spindle 200 by inserting pan head screw 340 into a tapped hole 215 in secondary spindle 200. Blade 300 has a countersunk arbor 370 which accepts the pan-shaped head of pan head screw 340. Thus, pan head screw 340 is flush mounted in blade 300. This allows toe-kick saw 100 to enter a toe-kick and cut flush up to its inner wall.

Spindle extension assembly 150 is covered in use by housing 400. Housing 400 includes face plate 220, tube 240, fixed guard 260, and movable guard 280. Housing 400 is screwed onto saw motor 120 using screws 35. The saw is guided along the inner wall of the toe-kick by the edges 360 of fixed guard 260. Edges 360 extend approximately 1/16″ past the vertical plane defined by blade 300 to prevent blade 300 and countersunk screw 340 from rubbing against the inner wall of the toe-kick. Edges 360 thus place blade 300 as close as possible to the inner wall of the toe-kick, thus cutting off as much of the old flooring material as possible.

The prior art toe-kick saw 100 has a fixed guard 260 which is as small as possible in order to fit in as wide a range of toe-spaces as possible. A small blade guard also enables toe-kick saw 100 to come as close as possible to a wall surface of the room which may abut the toe-kick (such as, an inside corner area). This ensures that the saw may be used within a toe-kick as prescribed by the instructions. However, users commonly misuse toe-kick saws. Despite instructions for proper usage and warnings to use the saw underneath toe-spaces only, and to cut forward and straight along the inner wall of the toe-space only, users misuse the tool by cutting outside the toe-space, by cutting sharp curves, or even by running the saw backwards by pulling it towards themselves. Such abuse may create the dangerous and well-known hazard common in the use of all circular saws called “saw kickback”. Saw kickback is caused when a saw blade may catch or become wedged on the edges of a saw kerf. This results in a sudden stoppage of the blade. Yet the spinning armature of the saw motor still has a great deal of stored kinetic energy. Since the blade is stuck and cannot move, the kinetic energy can cause the saw to react by kicking backward towards the user, creating a laceration hazard. To prevent saw kickback, some means to safely dissipate this stored kinetic energy is needed.

The spindle extension assembly 150 and blade driver 320 of prior art toe-kick saw 100 are unable to safely dissipate the stored kinetic energy. To provide a toe-kick saw which could safely dissipate the energy, it may be noted that the amount of torque in primary spindle 140 (or in spindle extension assembly 150, for that matter) is normally far greater at the time of saw kickback than under normal cutting conditions. A level of spindle torque which is in excess of that which is required for normal cutting, and which may create a kickback hazard, will be referred to herein as an “excess spindle torque”. Some means to disengage the motor and allow the spinning kinetic energy within it to be safely dissipated could reduce kickback hazards created by saw misuse.

### SUMMARY

To achieve these and other goals, an improved blade driver may be employed which itself may yield (as by bending) and thereby disengage the saw motor (and the entire spindle extension assembly) from the blade. Such will be referred to herein as a “yieldable blade driver”. When disengaged, a yieldable blade driver may ratchet against a plurality of drive holes in the blade to safely dissipate the saw motor's stored kinetic energy.

In another embodiment, a pair of drive plates may be added to the spindle extension assembly. One of said drive plates may be spring loaded such that both are pressed together. The pair of drive plates may further contain inner detents, where said detents define a cavity for holding steel balls. The detents in one of said pair of drive plates may be deeper, meaning the steel balls are lodged more deeply on this drive plate than the other. Thus, the ball bearings transmit increasing wedging force which tends to separate the pair of drive plates as spindle torque increases. At excess spindle torque, the pair of drive plates are forced apart, disengaging the saw motor from the rest of the spindle extension assembly. The ratcheting action of steel balls could safely dissipate the motor's kinetic energy. This means to dissipate the saw motor's kinetic energy will be referred to herein as a “yieldable spindle extension”

It is an object of one or more embodiments to provide an yieldable blade driver for driving a toe-kick saw blade which may disengage itself from the blade and dissipate the saw motor's kinetic energy at excess spindle torque. Such a yieldable blade driver may be inexpensive and field replaceable.

It is an object of one or more embodiments to provide a yieldable spindle extension assembly for a toe-kick saw which includes a means of disengaging itself at excess spindle torque from the saw motor and dissipate the saw motor's kinetic energy.

These and other objects may be achieved by forming a yieldable blade driver using a flat piece of metal, such as spring steel. The yieldable blade driver may include spherical drive nubs pressed into its face, which drive the blade. Under normal cutting conditions, the spherical drive nubs will transmit sufficient force to drive the blade. At excess spindle torque, the wedging action of the spherical nubs may cause the blade driver itself to bend and disengage from the blade, thereby disengaging the motor and the entire spindle extension assembly from the blade. The ratcheting action of the spherical drive nubs impacting drive holes on the blade may dissipate the saw motor's kinetic energy. Thus, a yieldable blade driver may be manufactured as a metal stamping. Such a yieldable blade driver would be inexpensive and just as field replaceable as the blade, because it is mounted in the same accessible location.

The objects may be achieved with an improved spindle extension assembly for a toe-kick saw which includes a first drive plate coupled to the primary spindle of the saw motor, and a second drive plate which is pressed against the first drive plate by a spring. In one embodiment, the inside faces of said first and second drive plate each have five detents. The detents in said first and second drive plates together define cavities for holding five steel balls. Under normal cutting conditions, the steel balls act as drive surfaces which transmit torque between said first drive plate and said second drive plate. However, these steel balls are seated more deeply in the first drive plate than the second, and thus engage the second drive plate with a shorter surface. At excess spindle torque, the steel balls act as a wedge or inclined plane and force the first and second drive plates apart. Thus, the spindle extension assembly would disengage itself from the saw motor in the event of an excess spindle torque. The ratcheting action of the steel balls impacting the drive detents on the second drive plate may dissipate the saw motor's kinetic energy.

### BRIEF DESCRIPTION OF THE DRAWINGS

FIG. 1 is a partially exploded view of a prior art toe-kick saw.

FIG. 2a is an exploded view of a toe-kick saw with a yieldable blade driver.

FIG. 2b is a front perspective view of the yieldable blade driver.

FIG. 3 is partially exploded view of an alternative embodiment of the yieldable blade driver in FIGS. 2a and 2b, in which the blade driver is made from two pieces of material.

FIG. 4 is a partially exploded view of an alternative embodiment of a yieldable blade driver which includes a solid blade driver and a dished washer.

FIG. 5 is an exploded view of a toe-kick saw with a spindle extension assembly which contains a pair of spring loaded drive plates.

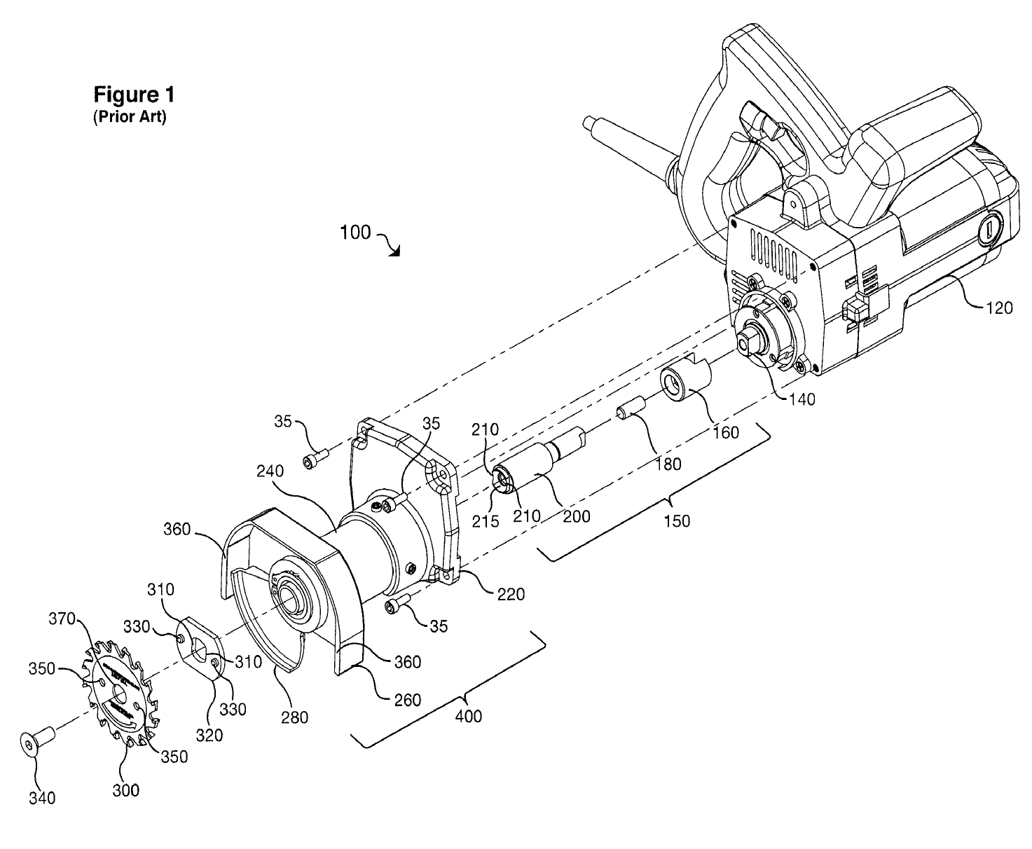

### DETAILED DESCRIPTION OF THE INVENTION

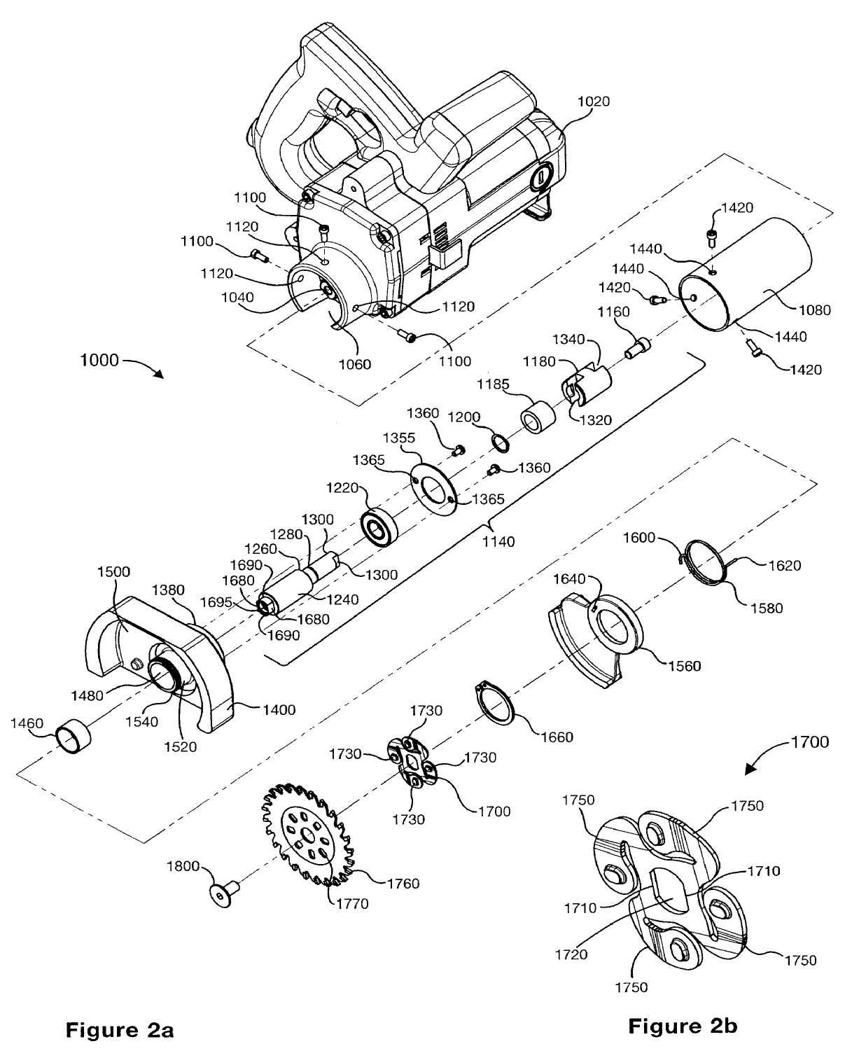

With reference to FIG. 2a, toe-kick saw 1000 includes a circular saw motor 1020 having an internal rotating armature (not shown) operatively coupled to a rotating spindle 1040. The housing of motor 1020 has an opening 1060 which accepts tube 1080. Tube 1080 is inserted and fastened into opening 1060 with three screws 1100 which run through three holes 1120.

Tube 1080 serves to house spindle extension assembly 1140. Spindle extension assembly 1140 includes screw 1160, spindle coupler 1180, spacer 1185, snap ring 1200, ball bearing 1220, and secondary spindle 1240. The assembly of these components goes as follows: Ball bearing 1220 is slipped onto secondary spindle 1240 and rests on shoulder 1260. Snap ring 1200 is seated in groove 1280. Spacer 1185 is then slipped onto secondary spindle 1240.

Next in the assembly is the mounting of spindle coupler 1180. Spindle coupler 1180 has a slot 1320 which accepts flats 1300 on secondary spindle 1240. Spindle coupler 1180 has a slot 1340 on the opposite end and a hole through its centerline (not shown). Screw 1160 goes through this centerline hole and fastens into a tapped centerline hole (not shown) on the inside end of secondary spindle 1240.

Once spindle coupler 1180 is fixed onto secondary spindle 1240, it may form a coupling for spindle extension assembly 1140 when slot 1340 is coupled to spindle 1040 (of motor 1020). Thus, spindle extension assembly 1140 is capable of transmitting force from saw motor 1020 to a blade driver at an extended distance.

Spindle extension assembly 1140 is housed within tube 1080. As previously explained, tube 1080 is inserted and fastened into opening 1060 of saw motor 1020. On the opposite end, tube 1080 is press fit onto boss 1380 on the back side of fixed guard 1400 and fastened with three screws 1420 through three holes 1440.

Internal support for spindle extension assembly 1140 is provided within fixed guard 1400 by ball bearing 1220 and bushing 1460. Bushing 1460 is press fit into a reamed counterbored hole 1480. Hole 1480 runs from the front of fixed guard 1400 all the way through to the opposite side of fixed guard 1400, where said counterbore (not shown) is located. Spindle extension assembly 1140 is then inserted though the back side of hole 1480 and bushing 1460 until ball bearing 1220 seats in said counterbore. Plate 1355 is placed on top of ball bearing 1220. Two screws 1360 are fastened into fixed guard 1400 through two holes 1365 in plate 1355. This fastens ball bearing 1220 into the counterbore and secures spindle extension assembly 1140 into fixed guard 1400.

When ball bearing 1220 is seated and fastened into said counterbore, the secondary spindle is prevented from sliding out by snap ring 1200. Spacer 1185 provides additional safety should snap ring 1200 fail. Spacer 1185 is larger in outside diameter than the center hole in ball bearing 1220, and thus also prevents spindle extension assembly 1140 from sliding out.

Practical problems of imprecise bearing alignment, runout, and motor vibration make manufacturing a circular saw with an extended spindle difficult. Connecting a separate secondary spindle (such as secondary spindle 1240) to the motor by way of spindle coupler 1180 is preferred because a controllable amount of play is allowed in the juncture between slot 1340 and primary spindle 1040. Without such play, even slight misalignment will result in runout or wobbling forces being transferred to ball bearing 1220 and bushing 1460. This reduces the life of the saw.

Fixed guard 1400 has a blade housing 1500 which contains cylindrical guard mount 1520. As with prior art toe-kick saws, a torsion spring 1580 and movable guard 1560 is placed onto cylindrical guard mount 1520. Torsion spring 1580 hooks on end 1620 into a hole inside blade housing 1500 (not shown) and on hook 1600 to a hole 1640 on primary movable guard 1560. When primary movable guard 1560 is retracted (as during a cutting operation), tension builds in torsion spring 1580 which urges primary movable guard 1560 to re-extend back to a forward guarding position. Cylindrical guard mount 1520 has snap ring groove 1540. Snap ring 1660 is seated into snap ring groove 1540 to hold primary movable guard 1560 and torsion spring 1580 in place.

The distal end of secondary spindle 1240 projects a sufficient distance into blade housing 1500 to expose flats 1680 and rounds 1690. Flats 1680 form the drive surfaces for a blade driver. Yieldable blade driver 1700 is mounted on the distal end of secondary spindle 1240. As shown more clearly in FIG. 2b, flats 1710 in arbor 1720 engage flats 1680 of secondary spindle 1240 (FIG. 2a). Thus, force is transmitted from the secondary spindle 1240 (FIG. 2a) to yieldable blade driver 1700. As shown in FIG. 2a, blade 1760 is next placed on the distal end of secondary spindle 1240 where it rests on rounds 1690. Blade 1760 is pressed against four spherical nubs 1730 of yieldable blade driver 1700. The four spherical nubs may seat in any four of eight concentric drive holes 1770 in blade 1760. Blade screw 1800 is fastened into a tapped hole 1695 in the distal end of secondary spindle 1240 to hold blade 1760 and yieldable blade driver 1700 on secondary spindle 1240. However, blade screw 1800 can tighten down only enough to leave a small gap between its inside surface and the outer surface of blade 1760. This gap is controlled by the depth of tapped hole 1695 in the end of secondary spindle 1240. Under normal cutting conditions, yieldable blade driver 1700 will transmit sufficient force to blade 1760 for cutting.

At excess spindle torque, the four of holes 1770 in blade 1760 which may be engaged with rounded nubs 1730 produce sufficient wedging pressure on nubs 1730 to bend arms 1750 (FIG. 2b) of yieldable blade driver 1700 backward. Thus nubs 1730 become disengaged from blade 1760. Blade 1760 stops. (The previously discussed small gap between the inside surface of blade screw 1800 and the inside surface of blade 1760 isolates blade 1760 from blade screw 1800. Rounds 1690 transfer little or no force.) The spinning kinetic energy of the motor is safely dissipated as the nubs 1730 of yieldable blade driver 1700 ratchet against the eight concentric drive holes 1770 of blade 1760. When motor power is sufficiently reduced, nubs 1730 may reseat in any four of eight concentric drive holes 1770. This allows yieldable blade driver 1700 to re-engage the blade, so that cutting at reduced spindle torque may resume. The nubs are illustrated as rounded nubs (i.e. the projecting ends of the nubs are curved) but any shape which causes the blade driver to yield and disengage from the blade at excess spindle torque, and thereafter reengage the blade at lower spindle torque, should be adaptable to the present embodiments (including those of FIGS. 2a, 2b, 3 and 4). Thus a nub with a facet or inclined end are also envisioned. The nubs illustrated are spherical (rounded ends) but any shape allowing unseating/reseating of the blade would be possible. Faceted heads are envisioned.

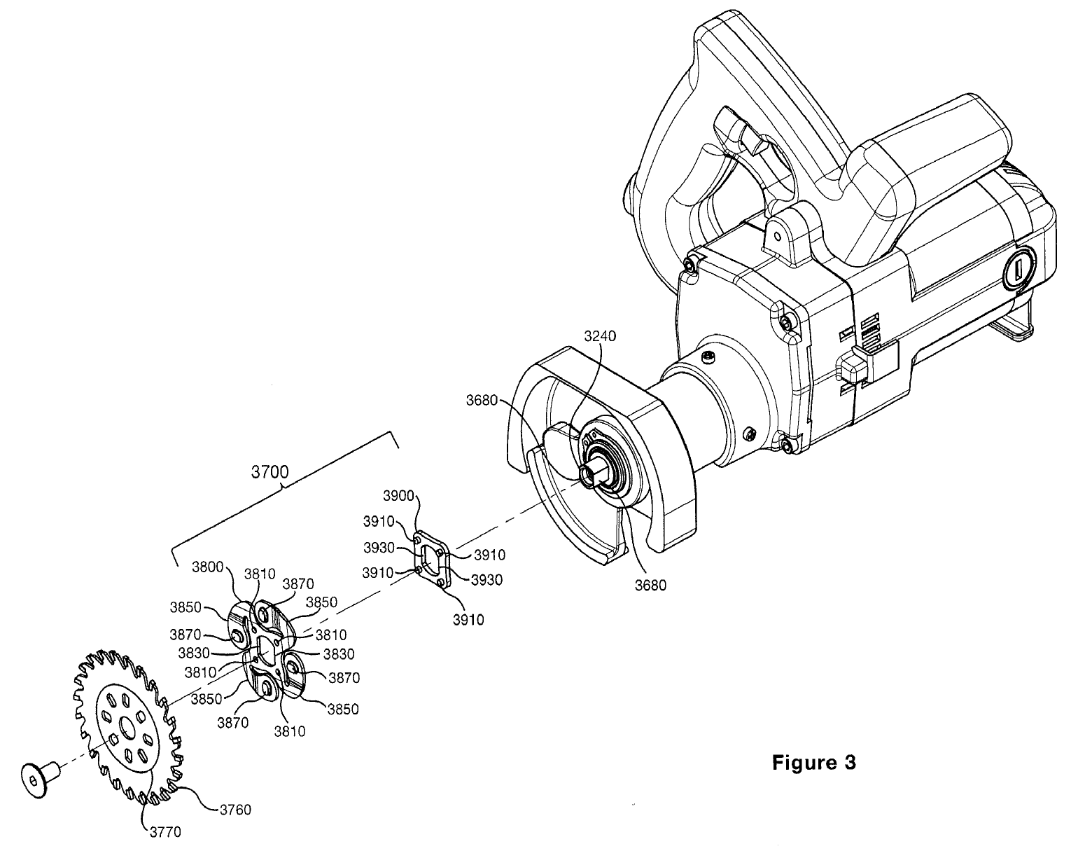

A yieldable blade driver for a toe-kick saw may have several embodiments. In another embodiment, the driver may be made in two parts in order to reduce the thickness of the arms. As shown in FIG. 3, yieldable blade driver 3700 consists of a first driver 3800 and a second back up plate 3900. Driver 3800 and back up plate 3900 are made to be spot welded or peened together as by inserting bosses 3910 of backup plate 3900 through holes 3810 of blade driver 3800. The combined thickness of flats 3830 of driver 3800 with flats 3930 of backup plate 3900 is comparable to the thickness of flats 1710 of the single piece yieldable blade driver 1700 of FIG. 2b. Thus, the bearing surface of the combined flats 3830, 3930 which bear against the drive flats 3680 on the secondary spindle 3240 will be comparable. This prevents premature wear on secondary spindle 3240. However, as shown in FIG. 3, the material used to form driver 3800 may be thinner. Using thinner materials to form arms 3850 is preferred for two reasons. First, thinner arms allow the four spherical nubs 3870 to disengage at lower spindle torque. Secondly, the thickness of arms 3850 determines the pressure put on the spherical nubs 3870 when they ratchet against the drive holes 3770 in the blade 3760 when the yieldable blade driver is disengaged. The reduced pressure from arms 3850 helps spherical nubs 3870 last longer.

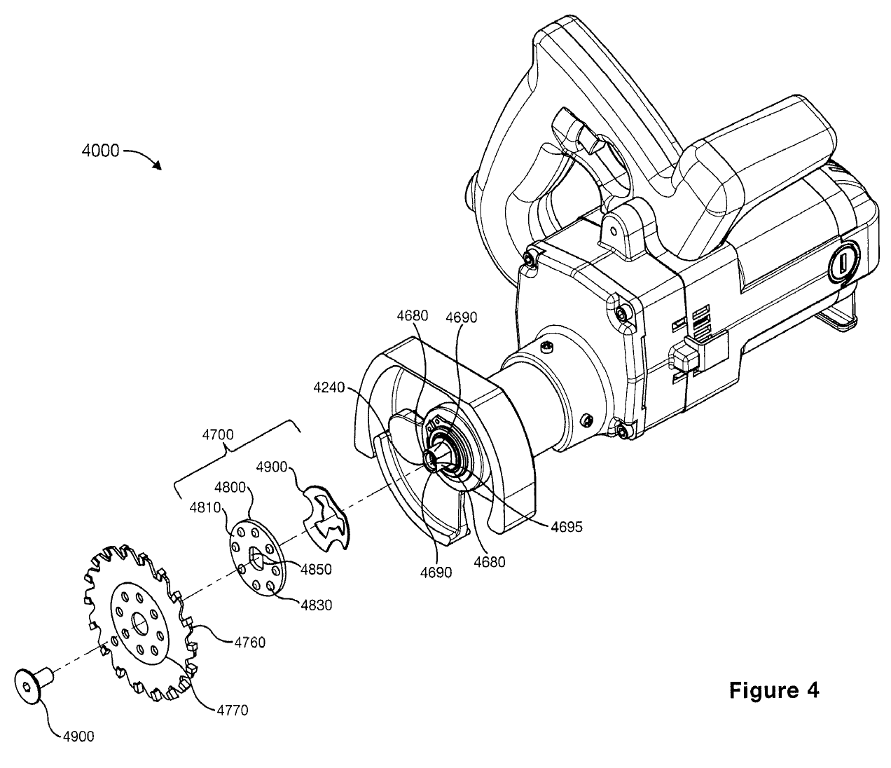

Another embodiment of a yieldable blade driver for a toe-kick saw which uses a combination of a solid driver and a dished washer is shown in FIG. 4. Yieldable blade driver 4700 includes solid driver 4800 and dished washer 4900 which acts like a spring. Dished washer 4900 is installed first on the end of secondary spindle 4240, followed by solid driver 4800. Solid driver 4800 is pressed against dish washer 4900. Solid driver 4800 has a thicker solid body 4810 which will not bend, and a concentric pattern of eight spherical drive nubs 4830. Force for driving the blade is transmitted from flats 4680 on the secondary spindle 4240 of toe-kick saw 4000 to flats 4850 of solid driver 4800. Under normal cutting conditions, solid driver 4800 will transfer sufficient force, each pressing against the eight spherical drive nubs 4830 contacting the concentric pattern of eight drive holes 4770 in blade 4760. However, as spindle torque increases, eight spherical drive nubs 4830 tend to wedge solid driver 4800 away from blade 4760, which puts pressure on dish washer 4900 and causes it to yield. At excess spindle torque, solid driver 4800 disengages from blade 4760, and the eight spherical drive nubs 4830 ratchet against the eight drive holes 4770 of blade 4760. Blade 4760 stops. (Secondary spindle 4240 of toe-kick saw 4000 has the same threaded hole 4690 with precise depth that maintains a small gap between the inner surface of screw 4900 and blade 4760, and rounds 4690 which both prevent any force from being transferred to blade 4760 during disengagement.) The spinning kinetic energy of the motor may be dissipated by the ratcheting of solid driver 4800 against blade 4760. Once the kinetic energy is sufficiently dissipated, dish washer 4900 will urge solid driver 4800 against blade 4760 with sufficient force to reengage the eight spherical drive nubs 4830 into the eight drive holes 4770 of blade 4760, and normal cutting may resume.

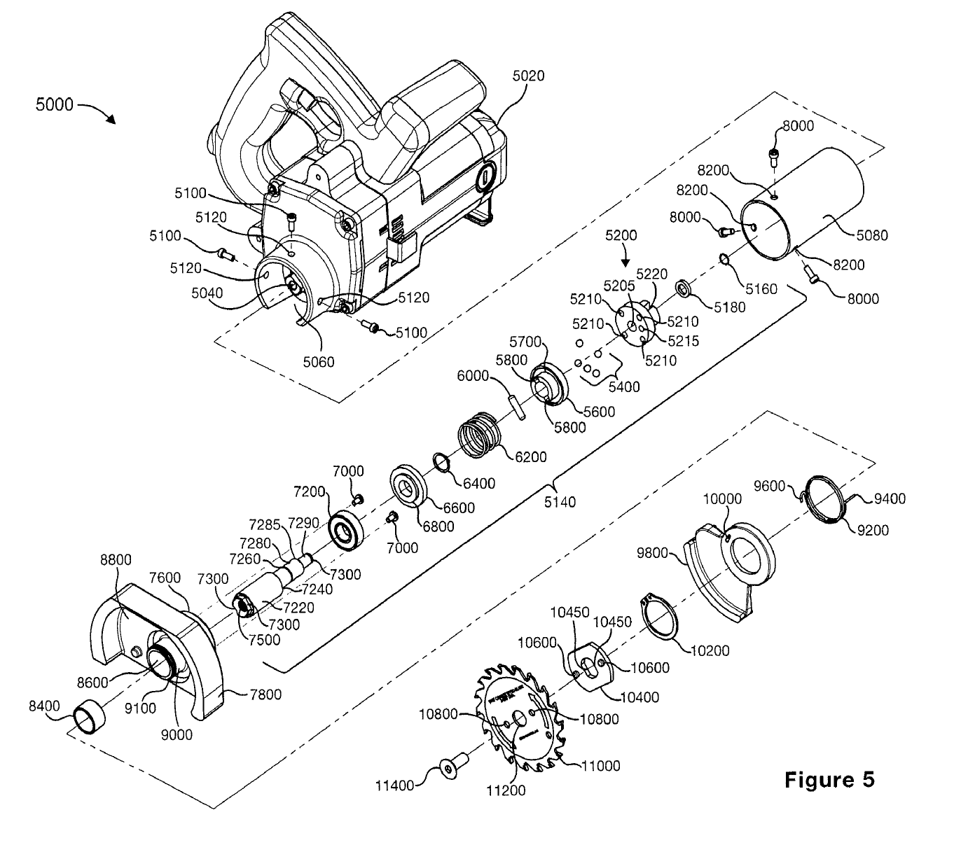

A different type of yieldable drive mechanism for a toe-kick saw may be a yieldable spindle extension. A yieldable spindle extension may include a pair of spring loaded drive plates which may allow the spindle extension assembly to disengage itself from the saw motor at excess spindle torque. As shown in FIG. 5, toe kick saw 5000 includes a motor 5020 with a rotating armature (not shown) operatively coupled to a rotating spindle 5040. The housing of motor 5020 has an opening 5060 which accepts tube 5080. Tube 5080 is inserted and fastened into opening 5060 with three screws 5100 which run through three holes 5120.

Tube 5080 serves to cover yieldable spindle extension 5140. Yieldable spindle extension 5140 includes wire-form retainer ring 5160, chamfered washer 5180, primary drive plate 5200, five steel balls 5400, secondary drive plate 5400, lock pin 6000, spring 6200, snap ring 6400, washer 6600, ball bearing 7200, and secondary spindle 7220. The assembly of these components goes as follows: Ball bearing 7200 is slid onto secondary spindle 7220 and rests on shoulder 7240. Washer 6600 is next slid onto secondary spindle 7220. Washer 6600 has a step 6800 which rests on the inside race (not shown) on the inside face of ball bearing 7200. Snap ring 6400 seats in first groove 7260 to lock ball bearing 7200 and washer 6600 in place.

Pin 6000 is inserted into a hole 7280 through secondary spindle 7220. Spring 6200 is placed over secondary spindle 7220 and is pressed on one end against washer 6600. On the opposite end, spring 6200 is pressed against a groove 5700 on secondary drive plate 5400 until the ends of pin 6000 seat in drive slots 5800 of secondary drive plate 5400. Five steel balls 5400 are inserted into five detents (not shown) on the inner face of secondary drive plate 5400. Four of these detents are concentric, while the one other detent is located on a shorter radius inside the concentric circle formed by the other four detents. Primary drive plate 5200 is placed against the inner face of secondary drive plate 5400 such that the five steel balls 5400 seat in five detents 5210, 5215 in primary drive plate 5200. The number and location of detents in primary drive plate 5200 correspond with those in the inner face of secondary drive plate 5400 (i.e., four detents 5210 are concentric, one detent 5215 is located on a shorter radius).

For reasons to be explained later in the discussion of how primary drive plate 5200 and secondary drive plate 5400 may disengage in use, the detents 5210, 5215 in primary drive plate 5200 are slightly deeper than those in secondary drive plate 5400. However, in the initial assembly, the two sets of detents in both primary drive plate 5200 and secondary drive plate 5400 are aligned to precisely define five cavities for holding five steel balls 5400.

To complete the assembly of the yieldable spindle extension 5140, primary drive plate 5200 is pressed onto the assembly of five steel balls 5400 and secondary drive plate 5400, until it slips over end 7290 of secondary spindle 7220 and rests against shoulder 7285. This further compresses spring 6200 and captures five steel balls 5400 between primary drive plate 5200 and secondary drive plate 5400. At this point, end 7290 of secondary spindle 7220 runs through hole 5205 of primary drive plate 5200 and projects into slot 5220. This exposes end 7290 and retainer groove 7300 within slot 5220 so chamfer washer 5180 and wire-form retainer ring 5160 can be mounted onto secondary spindle 7220 inside slot 5220. Thus, the entire assembly is locked in place by inserting wire-form retainer ring 5160 into retainer groove 7300 of secondary spindle 7220. The chamfer in chamfer washer 5180 is located on the outside surface (not shown) where it will bear against wire-form retainer ring 5160. The chamfer causes wire-form retainer ring 5160 to be compressed deeper into retainer groove 7300 as pressure from primary driver 5200 may increase. This offers greater holding strength than a snap ring (such as snap ring 6400). This completes the assembly of yieldable spindle extension 5140. Yieldable spindle extension 5140 is then coupled at slot 5220 to spindle 5040 of saw motor 5020, and is capable of transmitting rotational force at an extended distance while also yielding at excess spindle torque.

Yieldable spindle extension 5140 is housed within tube 5080. As previously explained, tube 5080 is inserted and fastened into opening 5060 of saw motor 5020. On the opposite end, tube 5080 is press fit onto boss 7600 on the back side of fixed guard 7800 and fastened with three screws 8000 through three holes 8200.

Internal support for yieldable spindle extension 5140 is provided within fixed guard 7800 by ball bearing 7200 and bushing 8400. Bushing 8400 is press fit into a reamed counterbored hole 8600. Hole 8600 runs all the way to the back side of fixed guard 7800, where the counterbore (not shown) is located. Yieldable spindle extension 5140 is then inserted through the back side of fixed guard 7800 through hole 8600 and bushing 8400 until ball bearing 7200 seats in the back side counterbore. Two screws 7000 are fastened on top of ball bearing 7200 to fasten it within the counterbore. Thus, yieldable spindle extension 5140 becomes fastened to fixed guard 7800.

Fixed guard 7800 has a blade housing 8800 which contains cylindrical guard mount 9000. A torsion spring 9200 and movable guard 9800 are mounted onto cylindrical guard mount 9000. Torsion spring 9200 hooks on end 9400 into a hole inside blade housing 8800 (not shown) and on a hook 9600 to a hole 10000 on movable guard 9800. When movable guard 9800 is retracted (as during a cutting operation), tension builds in torsion spring 9200 which urges movable guard 9800 to re-extend back to a forward guarding position. Cylindrical guard mount 9000 has a snap ring groove 9100. Snap ring 10200 is seated into snap ring groove 9100 to hold movable guard 9800 and torsion spring 9200 in place.

The distal end of secondary spindle 7220 projects a sufficient distance into blade housing 8800 to expose flats 7300. Flats 7300 engage flats 10450 on solid blade driver 10400. Solid blade driver 10400 has a pair of solid cylindrical projections 10600. Cylindrical projections 10600 engage drive holes 10800 of blade 11000. Blade 11000 has an arbor 11200 which is precision countersunk on its outside surface to seat the pan-shaped head of blade screw 11400. Because blade screw 11400 is fully recessed into countersunk arbor 11200, blade 11000 has a flush face, and is able to cut as closely as possible to the inner wall of a toe-kick.

The explanation of how yieldable spindle extension 5140 can disengage itself from spindle 5040 of saw motor 5020 is as follows: Yieldable spindle extension 5140 is coupled to spindle 5040 by slot 5220 in primary drive plate 5200. When spindle 5040 turns, primary drive plate 5200 will turn, and rotational force will be transferred to secondary drive plate 5400 through five steel balls 5400. Under normal cutting conditions, spring 6200 will hold secondary drive plate 5400 with sufficient force against primary drive plate 5200 that ball bearings 5400 will be captured between the detents on both drive plates, and will transfer force between them. However, as previously explained, the detents 5210, 5215 in primary drive plate 5200 are deeper than the corresponding detents in secondary drive plate 5400. The five steel balls 5400 protrude less than half their diameter from the inside face of primary 5200, and thus engage the opposite detents in secondary drive plate 5400 with less than half of the diameter of their surface. When force is applied, the surfaces of five steel balls 5400 which protrude from the inner face of primary drive plate 5200 act as a wedge or an inclined plane against the corresponding detents on secondary drive plate 5600. As greater force is applied, five steel balls 5600 will push secondary drive plate 5400 further away until they may become disengaged from secondary drive plate 5400. At excess spindle torque, primary drive plate 5200 and five balls 5400 will continue to spin (being more deeply socketed in detents 5210, 5215). The rest of yieldable spindle extension 5140 (as well as solid blade driver 10400 and blade 11000) will stop. This internally disengages yieldable spindle extension 5140, and dissipates the stored kinetic energy of the motor.

When motor power is sufficiently reduced, five steel balls 5400 will reseat within the shallower detents in secondary 5400. At such time, yieldable spindle extension 5140 is re-engaged, and normal cutting may continue.

As previously explained, primary drive plate 5200 and secondary drive plate 5400 each have five detents to hold five steel balls 5400. Four of these corresponding pairs of detents are concentric. However, the fifth pair of corresponding detents are formed on a shorter radius. The fifth pair of corresponding detents cause primary drive plate 5200 and five steel balls 5400 to spin at least one full turn before five steel balls 5400 will ratchet against the detents on secondary drive plate 5400. This reduces the number of damaging impacts that five steel balls 5400 may have on the detents in secondary drive plate 5400, extending the life of these components.

What is claimed is:

1. A toe-kick saw, comprising:
a saw motor having a spindle;
a spindle extension;
a tube section extending from said saw motor which covers said spindle extension;
a fixed blade guard on the end of said tube section which defines a housing for a circular saw blade; and
a yieldable blade driver mountable on said spindle extension, wherein said yieldable blade driver is yieldable by means of bending of said yieldable blade driver, said yieldable blade driver having one or more nubs for driving a circular saw blade;
wherein said blade driver is configured to allow mounting of a circular saw blade having one or more drive holes for accepting said one or more nubs, said saw blade securable by a blade screw that may be secured to hold said yieldable blade driver and said circular saw blade on said spindle extension.

2. The toe-kick saw of claim 1, wherein said yieldable blade driver is formed from a single piece of material.

3. The toe-kick saw of claim 1, wherein said yieldable blade driver is formed with a first blade driver component, and a second backup plate component joined to said first blade driver component, wherein said first blade driver component is a yieldable component, and said first blade driver component is yieldable by means of bending of said first blade driver component.

4. A toe-kick saw, comprising:
a saw motor having a spindle;
a spindle extension;
said tube section extending from said saw motor, said tube covering said spindle extension;
a fixed blade guard on the end of said tube section which defines a housing for a circular saw blade;
a solid blade driver having on its front face one or more nubs for driving a circular saw blade; and
a spring which presses against the back face of solid blade driver thereby urging said solid blade driver against a circular saw blade;
wherein said solid blade driver is configured to allow mounting of a circular saw blade having one or more drive holes for accepting said one or more nubs, said saw blade securable by a blade screw that may be secured to hold said solid blade driver, said spring, and said circular saw blade on said spindle extension.

5. A toe-kick saw, comprising:
a saw motor having a spindle;
a yieldable spindle extension, comprising;
a first drive plate operatively connected to said spindle, said first drive plate having one or more detents for a receiving a ball;
a second drive plate having one or more detents for receiving a ball;
one or more balls, each ball mountable within said detents of said first and second drive plates;
a spring yieldably pressing said second drive plate against said first drive plate; and
a secondary spindle which holds said first drive plate, said second drive plate, said one or more balls, and said spring;
a tube section extending from said saw motor which covers said yieldable spindle extension;
a fixed blade guard on the end of said tube section which defines a housing for a circular saw blade; and
a blade mount operatively coupled to said yieldable spindle extension, said blade mount having one or more drive nubs for driving a blade;
wherein said blade mount is configured to allow mounting of a circular saw blade having one or more drive holes, said saw blade securable by a blade screw that may be secured to hold said blade mount and said circular saw blade on said yieldable spindle extension.

6. The toe-kick saw of claim 5, wherein said one or more detents of said first and second drive plates include one or more corresponding concentric detents in relation to the centerline of said first and second drive plates, and at least one detent which is located on a different radius in relation to the centerline of said first of and second drive plates than said concentric detents.
